(19) United States
(12) Patent Application Publication
(10) Pub. No.: US 2012/0153007 A1
(43) Pub. Date: Jun. 21, 2012

(54) METHOD OF AN APPARATUS FOR FRICTION STIR SPOT WELDING WITH ADAPTED NUMBER OF SHOULDERS WITH RESPECT TO THICKNESSES OF PLATES TO BE SPOT WELDED

(75) Inventors: Jörgen Säll, Laxa (SE); Per Eriksson, Karlskoga (SE)

(73) Assignee: ESAB AB, GOTEBPRG (SE)

(21) Appl. No.: 13/321,110

(22) PCT Filed: Jun. 4, 2010
(86) PCT No.: PCT/EP10/57844

§ 371 Date: Mar. 6, 2012

(30) Foreign Application Priority Data
Jun. 26, 2009 (SE) 0950492-9

(51) Int. Cl. B23K 20/12

(52) U.S. Cl. 228/112.1; 228/2.1

(57) ABSTRACT

A method and an apparatus for friction stir spot welding together at least two metal sheets is described. A tool comprising a stepwise decreasing diameter towards the welding end is used. Each stepwise decrease in diameter defines a shoulder. The first shoulder is situated at a distance (x) from the welding end which is larger than zero and smaller than the minimum thickness (Wmin) of one of the metal sheets, and wherein a higher number of shoulders than the number of metal sheets to be joined, are situated within a distance (L) from the welding end that is smaller than the maximum thickness (Wmax) of a metal sheet times the number of metal sheets to be joined minus one.

### TECHNICAL FIELD

The present invention relates to a method and apparatus for friction stir spot welding. More specifically the present invention relates to a method and apparatus for friction stir spot welding of sheets with varying thickness.

### DESCRIPTION OF THE PRIOR ART

Friction Stir Spot Welding (FSSW) is a technique that originates from traditional Friction Stir Welding (FSW). The technique is applied as the traditional process except that no traverse motion is being used. Instead only the downwards motion (plunge) and the retracting motion is applied having the tool in a rotating motion. Various extensions to this technique exist, which enhance the quality of the joint, e.g. by moving the tool around or having the plunging operation being applied with two separate motions using a retractable pin tool. The use of FSSW allows rapid joining without consumables which may be used as a replacement for joining with traditional rivets.

One common issue is that the sheets being spot welded may have a varying thickness. Firstly, if a position based plunge is applied using a traditional FSW tool the shoulder may “over-plunge” the material (plunge too deep into the upper sheet) or, even worse, not make contact with the material at all. Secondly, the pin of the traditional tool must have a length that is adapted to the thickness of the sheets to be joined. The pin should neither exceed the thickness of the plates to be joined nor be too short and not fully plunge into the lower sheet. In the latter case the joint may not be formed.

As one of the main reasons for applying a FSSW joint is the speed by which the joint may be applied, the time cycle must be kept as short as possible. During a traditional plunge only little heat is generated as the pin part of the tool is being plunged. As the shoulder part of the tool makes contact with the material a high torque is generated. If the downwards speed of the tool during the plunge is to be maximized, the extreme torque of the traditional plunge will cause an undesirably high load for the FSW machine, which in worst case may damage the machine or the FSW tool.

The Japanese Patent application JP 2001-321967 describes a tool for friction stir spot welding of three metal sheets. The tool has a tapered pin with decreasing diameter towards the end. The tool also has a conventional shoulder which is arranged to be in the surface of the top metal sheet during welding.

When two sheets of metal are to be joined using FSSW the tool is arranged so that the pin is sufficiently long to penetrate through the entire top sheet and into the bottom sheet when the shoulder is in contact with the top surface of the top sheet. When the thickness of the sheets varies it is necessary to change the tool that is used for the FSSW so that the pin of the tool penetrates into the bottom sheet without penetrating through the bottom sheet. It is; however, time consuming to have to change the tool each time the thickness of the sheets change.

### SUMMARY OF THE INVENTION

An object of the present invention is to provide a method and a device for friction stir spot welding, which provides a satisfactory welding result without changing the tool used for the friction stir spot welding when the thickness of the metal sheets varies within a predetermined interval.

The above object is fulfilled with a method and a device according to the independent claims.

Further advantages of the invention are achieved with the features of the dependent claims.

A basic idea of the present invention is to use a friction stir welding tool with a number of shoulders that exceeds the number of metal sheets to be welded.

A method for friction stir spot welding according to a first aspect of the present invention comprises the step of arranging at least two metal sheets on a supporting plane at least partially over-lapping each other, wherein each sheet perpendicularly to the supporting plane has a thickness within an interval from a minimum thickness to a maximum thickness. The method further comprises the step of providing a tool with a length axis, which tool at a welding end comprises an end part, which is circularly symmetrical around the length axis, which is arranged to make contact with the metal sheets during welding, and which comprises a stepwise decreasing diameter towards the welding end, wherein each stepwise decrease in diameter defines a shoulder, and also comprises the step of rotating the tool during welding. The method is characterized in that it also comprises the step of during welding, moving the tool along its length axis towards the supporting plane to a predefined position in which a distance between the welding end and the supporting plane is larger than zero and smaller than the minimum thickness of one of the metal sheets. The first shoulder is situated at a distance from the welding end which is smaller than half the minimum thickness of one of the metal sheets, and a higher number of shoulders than the number of plates to be joined, are situated within a distance from the welding end that is smaller than the maximum thickness of a metal sheet times the number of metal sheets to be joined minus one.

With a method according to the first aspect of the invention a satisfactory friction stir spot welding result may be achieved for metal sheets within a large range of thicknesses. Shoulders may be positioned at the necessary positions in the metal sheets.

The factor between the smallest decrease in diameter at a shoulder and the largest decrease in diameter at a shoulder may be in the interval 1-2. It is of course possible to have larger decreases in diameter, but the interval 1-2 provides good friction stir spot welding results.

The method may comprise the starting of the rotation of the tool at a distance from the metal sheets, which is less than the maximum thickness of the metal sheets. This provides for a smaller risk for involuntary welding in case the tool hits anything on its way during movement to the welding position. It is, however, possible to start the rotation at an arbitrary distance from the metal sheets.

Preferably the method comprises the step of orientating the length axis of the tool essentially perpendicular to the planes defined by the metal sheets. This orientation of the tool gives the best friction stir spot welding result. It is, however, possible to arrange the tool with the length axis in other angles in relation to the metal sheets.

The method may comprise the step of retracting the tool from the predefined position within a predefined time period from reaching the predefined position, which predefined time period is less than 1 second. It is advantageous to retract the tool as soon as possible after reaching the predefined position with 1 second being an upper limit.

The metal sheets that may be used belong to different groups of metal sheets, wherein the thickness of each sheet in a group is essentially the same. In other words this means that there are a finite number of possible combinations of thicknesses. The thickness of each one of the plates is determined by the group of metal sheets to which it belongs.

The distance along the length axis between the shoulders on the tool used is preferably essentially equal to the smallest difference in thickness between sheets from two different groups. Welding of two metal sheets may result in a specific shoulder being at the top of the top metal sheet. If the top metal sheet is replaced with a sheet from the next thicker group the specific shoulder will be positioned lower into the top metal sheet. If, however, the next shoulder is positioned at a distance being equal to the difference in thickness the next shoulder will be positioned at the same depth in the top metal sheet as the above mentioned specific shoulder.

According to a second aspect of the present invention an apparatus is provided for friction stir spot welding of at least two metal sheets being arranged on a supporting plane and at least partially overlapping each other. Each sheet has, perpendicularly to the supporting plane, a thickness within an interval from a minimum thickness to a maximum thickness. The apparatus comprises a tool with a length axis, around which the tool is arranged to be rotated during welding, which tool at a welding end comprises an end part, which is circularly symmetrical around the length axis, which comprises a stepwise decreasing diameter towards the welding end, wherein each stepwise decrease in diameter defines a shoulder, and which is arranged to make contact with the metal sheets during welding. The apparatus is characterized in that the apparatus during welding is arranged to move the tool along its length axis towards the supporting plane to a predefined position in which a distance between the welding end and the supporting plane is larger than zero and smaller than the minimum thickness of one of the metal sheets, that the first shoulder is situated at a distance from the welding end which is smaller than half the minimum thickness of one of the metal sheets, and wherein a higher number of shoulders than the number of sheets to be joined, are situated within a distance from the welding end that is smaller than the maximum thickness of a metal sheet times the number of metal sheets to be joined minus one.

The factor between the smallest decrease in diameter at a shoulder and the largest decrease in diameter at a shoulder may be in the interval 1-2. It is of course possible to have larger decreases in diameter, but the interval 1-2 provides good friction stir spot welding results.

The apparatus may be arranged to start the rotation of the tool at a distance from the metal sheets, which is less than the maximum thickness of the metal sheets. This provides for a smaller risk for involuntary welding in case the tool hits anything on its way during movement to the welding position. It is, however, possible to start the rotation at an arbitrary distance from the metal sheets.

Preferably the apparatus is arranged so that the length axis of the tool is orientated essentially perpendicular to the planes defined by the metal sheets. This orientation of the tool gives the best friction stir spot welding result. It is, however, possible to arrange the tool with the length axis in other angles in relation to the metal sheets.

The apparatus may be arranged to retract the tool from the predefined position within a predefined time period from reaching the predefined position, which predefined time period is less than 1 second. It is advantageous to retract the tool as soon as possible after reaching the predefined position with 1 second being an upper limit.

The apparatus may be arranged to use metal sheets that belong to different groups of metal sheets, wherein the thickness of each sheet in a group is essentially the same. In other words this means that there are a finite number of possible combinations of thicknesses. The thickness of each one of the plates is determined by the group of metal sheets to which it belongs.

The distance along the length axis between the shoulders is preferably essentially equal to the smallest difference in thickness between sheets from two different groups. Welding of two metal sheets may result in a specific shoulder being at the top of the top metal sheet. If the top metal sheet is replaced with a sheet from the next thicker group the specific shoulder will be positioned lower into the top metal sheet. If, however, the next shoulder is positioned at a distance being equal to the difference in thickness the next shoulder will be positioned at the same depth in the top metal sheet as the above mentioned specific shoulder.

In the following preferred embodiments of the invention will be described with reference to the appended drawings.

### SHORT DESCRIPTION OF THE DRAWINGS

FIG. 1 shows schematically an apparatus 1 according to an embodiment of the present invention.

FIG. 2 shows schematically a tool during a welding operation on a first set of metal sheets.

FIG. 3 shows schematically the tool in FIG. 2 during a welding operation on second set of metal sheets which are thicker than the metal sheets in FIG. 2.

FIG. 4 shows a tool according to an alternative embodiment of the present invention.

### DESCRIPTION OF PREFERRED EMBODIMENTS OF THE INVENTION

In the following description of preferred embodiments of the invention the same reference numeral will be used for similar

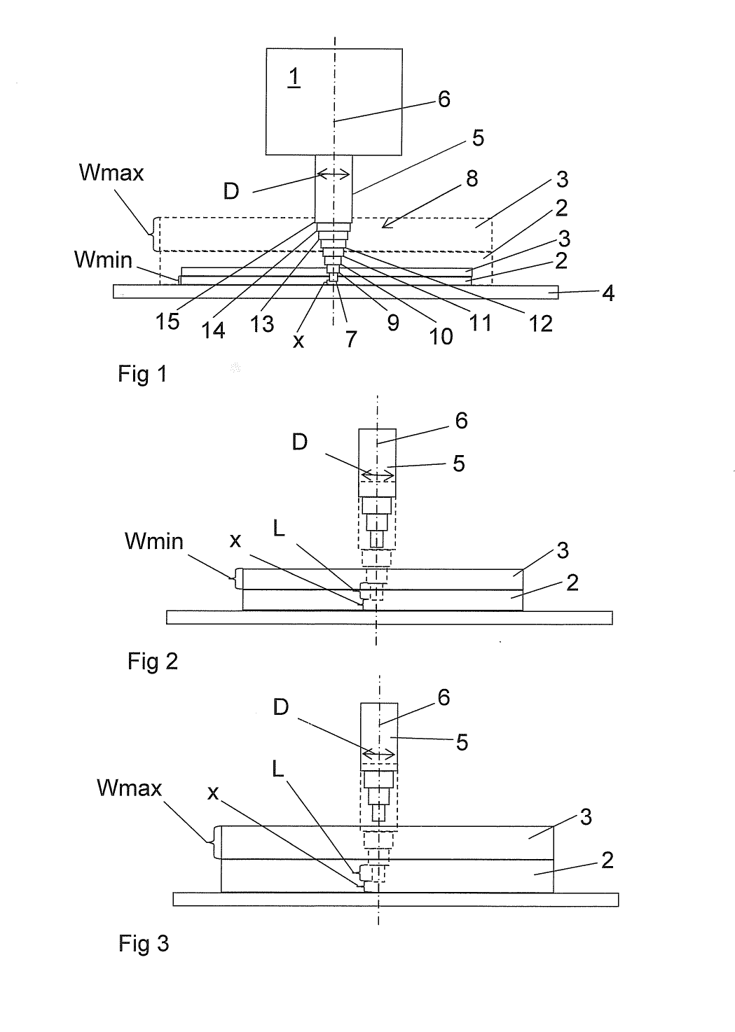

FIG. 1 shows schematically an apparatus 1 according to an embodiment of the present invention. The apparatus is intended for friction stir spot welding of at least two metal sheets 2, 3, being arranged against a supporting plane 4 and at least partially overlapping each other as shown in FIG. 1. Each sheet has, perpendicularly to the supporting plane, a thickness within an interval from a minimum thickness Wmin to a maximum thickness Wmax. The apparatus 1 comprises a tool 5 with a length axis 6, around which the tool 5 is arranged to be rotated during welding. The length axis 6 of the tool 5 is arranged to be essentially perpendicular to the planes defined by the metal sheets 2, 3. It is of course possible to arrange the tool 5 at another angle in relation to the metal sheets 2, 3. At a welding end 7 the tool 5 comprises an end part 8, which is circularly symmetrical around the length axis 6. The end part 8 comprises a stepwise decreasing diameter towards the welding end 7, wherein each stepwise decrease in diameter defines a shoulder 9. The largest diameter of the tool 5 is denoted D in FIG. 1. The end part 8 is arranged to make contact with the metal sheets 2, 3, during welding.

During welding the apparatus 1 is arranged to move the tool 5 along its length axis 6 towards the supporting plane 4 to a predefined position in which the distance between the welding end 7 and the supporting plane 4 is smaller than the minimum thickness of one of the metal sheets 2, 3. The tool 5 is situated in the predefined position in which the distance x between the welding end 7 and the supporting plane 4 is smaller than the minimum thickness of one of the metal sheets 2, 3. The metal sheets that may be used belong to at least two groups of metal sheets 2, 3, wherein the thickness of each sheet 2, 3, in a group is essentially the same. In the embodiment shown in FIG. 1, each metal sheet 2, 3, may have a thickness in the interval 6-24 millimeters in steps of 6 millimeters. Thus, the metal sheets 2, 3, belong to five different groups. In FIG. 1 are a first metal sheet 2 and a second metal sheet 3, which each has a thickness of 6 millimeter, shown with full lines. The first metal sheet 2 and the second metal sheet 3, each having a thickness of 24 millimeters, are shown with dotted lines.

The tool 5 comprises seven shoulders 9-15. The first shoulder 9 is situated at a distance from the welding end 7 which is larger than zero (preferably at least 1/10 of the minimum thickness of one of the metal sheets 2, 3) and smaller than the minimum thickness of one of the metal sheets 2, 3. This ensures that at least one shoulder 9-15 is plunged into the top metal sheet 3 for the minimum thickness of the metal sheets 2, 3. Furthermore, a higher number of shoulders 9, 10, 11 than the number of metal sheets 2, 3, to be joined, are situated within a distance from the welding end 7 that is smaller than the maximum thickness of a metal sheet 2, 3, times the number of metal sheets 2, 3, to be joined minus one. As is shown in FIG. 1 a first shoulder 9 is plunged into the top sheet 3 for the minimum thickness of the metal sheets 2, 3. Furthermore, all shoulders 9-15 of the tool 5 are plunged into the metal sheets 2, 3, for the maximum thickness of the metal sheets 2, 3, as shown by the dotted lines. The method for welding will be described with reference to FIG. 2 below.

FIG. 2 shows schematically a tool 5 during a welding operation on a first set of metal sheets 2, 3. The tool 5 has three shoulders 9, 10, 11. The full line shows the starting position of the tool 5, at which position the rotation of the tool 5 is started. There is a predetermined distance between the welding end 7 and the top metal sheet 3 in the starting position. The predetermined distance x between the welding end 7 and the top metal sheet 3 is less than the maximum thickness Wmax of the metal sheets 2, 3. The tool 5 is then plunged into the metal sheets during rotation of the tool 5 until the welding end 7 is at a distance x from the supporting plane 4 as is shown by the dotted lines. When the tool 5 has reached the position shown by the dotted lines it is quickly retracted from the metal sheets 2, 3. The tool 5 is arranged to be retracted from the predefined position, shown by the dotted lines, within a predefined time period from reaching the predefined position. The predefined time period is preferably less than 1 second. As is shown in FIG. 2, only the first shoulder 9 is plunged into the metal sheets 2, 3, during welding of metal sheets having a minimum thickness Wmin.

FIG. 3 shows schematically the tool 5 in FIG. 2 during a welding operation on a second set of metal sheets 2, 3, which are thicker than the metal sheets 2, 3, in FIG. 2. The welding operation is performed in the same way as was described for FIG. 2 above. As the metal sheets 2, 3, are thicker than in the embodiment shown in FIG. 2, all three shoulders 9, 10, 11, of the tool 5 will be in contact with the metal sheets 2, 3, when the welding end of the tool is at a distance x from the supporting plane.

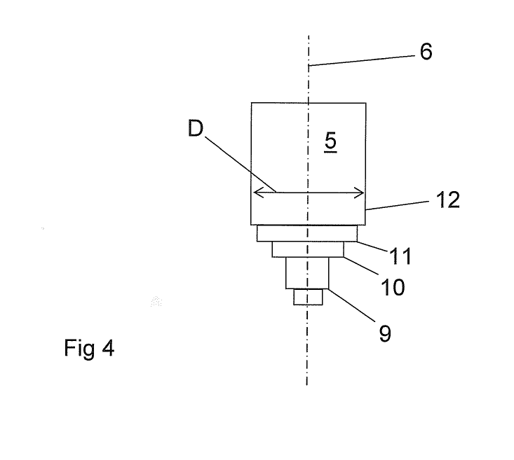

FIG. 4 shows a tool 5 according to an alternative embodiment of the present invention. The tool 5 shown in FIG. 4 comprises four shoulders 9-12. The decrease in diameter at the shoulders 9-12 vary along the tool 5. The smallest decrease in diameter is at the first shoulder 9 and the fourth shoulder 12, while the largest decrease in diameter is at the second shoulder 10 and the third shoulder 11. The factor between the smallest decrease in diameter at a shoulder 9 and the largest decrease in diameter at a shoulder 10 is 2. The distance along the length axis 6 between two different shoulders 9-12 varies along the tool 5. The smallest distance between two different shoulders 9-12 is essentially equal to the smallest difference in thickness between sheets 2, 3, from two different groups. Furthermore, the distance along the length axis 6 between the different shoulders 9-12 varies, with the distance between the first shoulder 9 and the second shoulder 10 being the largest, and all remaining distances between adjacent shoulders 9-12 being equal.

The described embodiments may be amended in many ways without departing from the spirit and scope of the present invention which is limited only by the appended claims.

It is possible to friction stir spot weld more than two metal sheets using the method of the invention.

In the above described embodiments both metal sheets have the same thickness. It is, however, possible to weld together metal sheets having different thicknesses.

1. A method for friction stir spot welding comprising the steps of:
arranging at least two metal sheets on a supporting plane at least partially overlapping each other, wherein each metal sheet perpendicularly to the supporting plane has a thickness within an interval from a minimum thickness (Wmin) to a maximum thickness (Wmax);
providing a tool with a length axis, wherein the tool at a welding end comprises an end part, which is circularly symmetrical around a length axis, wherein the end part is arranged to make contact with the metal sheets during welding, and which comprises a stepwise decreasing diameter towards a welding end, wherein each stepwise decrease in diameter defines at least one shoulder; and
rotating the tool during welding, characterized in that the method comprises the steps of:
during welding, moving the tool along its length axis towards the supporting plane to a predefined position in which a distance (x) between the welding end and the supporting plane is larger than zero and smaller than the minimum thickness (Wmin) of one of the metal sheets, wherein a first shoulder is situated at a distance from the welding end which is smaller than half the minimum thickness (Wmin) of one of the metal sheets, and wherein a higher number of shoulders than the number of metal sheets to be joined, are situated within a distance (L) from the welding end that is smaller than the maximum thickness (Wmax) of a metal sheet times a number of metal sheets to be joined minus one.

2. The method according to claim 1, comprising the step of using the tool which is arranged so that the factor between a smallest decrease in diameter (D) at a shoulder and a largest decrease in diameter (D) at a shoulder is in the interval 1-2.

3. The method according to claim 1, comprising starting of the rotation of the tool at a predetermined distance (x) from the metal sheets, which distance is less than the maximum thickness (Wmax) of the metal sheets.

4. The method according to claim 3, comprise the step of orientating the length axis of the tool essentially perpendicular to the planes defined by the metal sheets.

5. The method according to claim 1, comprising the step of retracting the tool from the predefined position within a predefined time period from reaching the predefined position, which predefined time period is less than 1 second.

6. The method according to claim 1, wherein the metal sheets that are used belong to different groups of metal sheets, wherein the thickness of each metal sheet in a group is essentially the same.

7. The method according to claim 6, wherein the distance along the length axis between the shoulders is essentially equal to the smallest difference in thickness between metal sheets from two different groups.

8. An apparatus for friction stir spot welding of at least two metal sheets being arranged on a supporting plane and at least partially overlapping each other, wherein each metal sheet perpendicularly to the supporting plane has a thickness within an interval from a minimum thickness (Wmin) to a maximum thickness (Wmax), wherein the apparatus comprises a tool with a length axis, around which the tool is arranged to be rotated during welding, wherein the tool at a welding end comprises an end part, which is circularly symmetrical around the length axis, the end part further comprises a stepwise decreasing diameter (D) towards the welding end, wherein each stepwise decrease in diameter (D) defines a shoulder, and wherein the end part is arranged to make contact with the metal sheets during welding, characterized in that the apparatus, during welding, is arranged to move the tool along its length axis towards the supporting plane to a predefined position in which a distance (x) between the welding end and the supporting plane is larger than zero and smaller than the minimum thickness (Wmin) of one of the metal sheets, wherein a first shoulder is situated at a distance from the welding end which is smaller than half the minimum thickness (Wmin) of one of the at least two metal sheets, and wherein a higher number of shoulders than the number of metal sheets to be joined, are situated within a distance (L) from the welding end that is smaller than the maximum thickness (Wmax) of a metal sheet times a number of metal sheets to be joined minus one.

9. The apparatus according to claim 8, wherein the factor between a smallest decrease in diameter at a shoulder and a largest decrease in diameter at a shoulder is in the interval 1-2.

10. The apparatus according to claim 8, wherein the rotation of the tool (5) is arranged to be started at a predetermined distance (x) from a top metal sheet, which distance (x) is less than the maximum thickness (Wmax) of the metal sheets.

11. The apparatus according to claim 8, wherein the length axis of the tool is arranged to be essentially perpendicular to planes defined by the metal sheets.

12. The apparatus according to claim 1, wherein the tool is arranged to be retracted from the predefined position within a predefined time period from reaching the predefined position, which predefined time period is less than 1 second.

13. The apparatus according to claim 1, wherein the apparatus is arranged to use metal sheets belonging to different groups of metal sheets, wherein the thickness of each metal sheet in a group is essentially the same.

14. The apparatus according to claim 13, wherein the distance along the length axis between the shoulders is essentially equal to a smallest difference in thickness between metal sheets from two different groups.
